(19) United States
(12) Patent Application Publication
(10) Pub. No.: US 2008/0220743 A1
(43) Pub. Date: Sep. 11, 2008

(54) CUSTOMIZATION OF MOBILE STATIONS

(75) Inventors: Eric Gilles Mora, Les Lilas (FR); Yves Maitre, Paris (FR)

Correspondence Address: KNOBBE MARTENS OLSON & BEAR LLP, 2040 MAIN STREET, FOURTEENTH FLOOR, IRVINE, CA, 92614, US

(73) Assignee: Orange SA, London (GB)

(21) Appl. No.: 12/041,569

(22) Filed: Mar. 3, 2008

Related U.S. Application Data
(63) Continuation of application No. PCT/EP2006/065911, filed on Sep. 1, 2006.

(30) Foreign Application Priority Data
Sep. 1, 2005 (EP) 05291820.8

(51) Int. Cl. H04M 1/66

(52) U.S. Cl. 455/411

(57) ABSTRACT

A method of customizing a mobile station in a mobile telecommunications system. A portable authentication module is provided for insertion into the mobile station, the authentication module comprising a function for authenticating a subscriber in the mobile telecommunications system when the authentication module is inserted in the mobile station. The authentication module further includes one or more software applications for customizing the mobile station. The one or more customizing software applications are transferred onto the mobile station in response to insertion of the authentication module into the mobile station, and then activated, in order to customize the mobile station.

### CROSS-REFERENCE TO RELATED APPLICATIONS

This application is a continuation, under 35 U.S.C. § 120, of International Patent Application No. PCT/EP2006/065911, filed Sep. 1, 2006 under the Patent Cooperation Treaty (PCT), which was published by the International Bureau in English on Mar. 8, 2007, with International Publication Number WO 2007/026013 A1, which designates the United States and claims the benefit of EP Application No. 05291820.8, filed Sep. 1, 2005. All above-referenced prior applications are incorporated by reference herein in their entirety and are hereby made a portion of this specification.

### BACKGROUND OF THE INVENTION

1. Field of the Invention

The present invention relates to the customization of mobile stations, in particular such mobile stations for use in mobile communications networks. The invention also relates to mobile stations which are adapted for receiving such customization and portable authentication modules for use with such mobile stations.

2. Description of the Related Technology

A mobile communications network such as a GSM network typically supports a number of communications terminals, known as mobile stations, which are adapted for making use of at least some of the services offered by the mobile communications network, such as making and receiving telephone calls, and receiving and sending data.

Access to services provided by mobile communications networks is generally restricted, and users need to take out subscriptions to make use of the services. Authorised users, i.e. subscribers, need a means of authenticating themselves to the mobile communications network. In the case of GSM, UMTS and other types of networks, the subscribers receive for this purpose a portable authentication module which can be ported between different mobile stations. Examples of such portable identification authentication module include Subscriber identity modules (“SIMs” or “SIM cards”), Universal Subscriber identity modules (“USIMs” or “USIM cards”) and Universal Integrated Circuit Cards (“UICCs” or “UICC cards”).

The portable authentication module is generally provided to the subscriber by the network operator. In addition to providing an authentication function, it stores standard data records for use by the mobile station. Such standard data records include subscriber data records storing information such as a contacts directory, and telecommunications data records which store information such as network settings for the mobile station. On insertion into a mobile station, the mobile station is able to read the standard data records, store data copied from them in a working memory on the mobile station, and update some of the data records during usage of the mobile station.

As mentioned above, the portable authentication module can be ported between different mobile stations, and the subscriber is not generally restricted to the use of a particular mobile station. However, when a subscriber joins a network operator the subscriber generally also receives a mobile station provided by the network operator. Many mobile network operators provide non-standard features on the mobile stations which they provide to their subscribers. These features range from external decoration, for example a logo, to the entire physical design of the mobile station (many operators have one or more exclusive models which are only available via that operator.) Also, many operators offer customized services to provide a recognizable “signature” uniquely associated with the mobile operator. Such services can be provided through customizing software applications installed on the mobile station.

These customizing software applications are typically installed in a read-only memory of the mobile station by the manufacturer of the mobile station, on behalf of the mobile operator. This customization during manufacture of the mobile station leads to additional cost, and a degree of inflexibility to the mobile operator in altering the selection of customizing software applications on a mobile station. Further, if the subscriber changes mobile stations, the customization may be different or lost entirely, and this is inconvenient to the subscriber.

U.S. Pat. No. 6,311,241 and U.S. Pat. No. 6,484,024 describe systems where customizing software applications are transferred from a “cargo card” or a “plug-in card” which is inserted into the same slot as a SIM card. A problem with these types of system is that the customization is dependent upon the subscriber performing an application loading operation, which is difficult to ensure. As a result, the desired customization often does not occur and the desired user experience is not obtained when the subscriber makes use of the services provided by the operator.

A further known way of customizing a mobile station is using a so-called SIM Toolkit application, which can be pre-installed or downloaded to a SIM. SIM Toolkit is a set of functions provided in a SIM which allows the SIM to control, amongst other things, the display on a mobile station. However, the range of functionality provided is relatively limited. Java Card™ technology provides a secure environment for applications that run on smart cards and other devices with very limited memory and processing capabilities. Multiple applications can be deployed on a single card, and new ones can be added to it even after it has been issued to the end user. Applications written in the Java™ programming language can be executed securely on cards from different vendors. Java SIM cards are now common; however, again, the range of functionality provided is also limited. It is an object of the present invention to provide an improved and more convenient customization of mobile stations.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In a first aspect, a method of customizing a mobile station in a mobile telecommunications system is provided. The method includes providing a portable authentication module for insertion into the mobile station, the authentication module comprising a function for authenticating a subscriber in the mobile telecommunications system when the authentication module is inserted in the mobile station, and the authentication module further comprising one or more software applications for customizing the mobile station; transferring the one or more customizing software applications from the authentication module onto the mobile station in response to insertion of the authentication module into the mobile station, and then activating the one or more customizing software applications on the mobile station, in order to customize the mobile station; and de-activating the one or more customizing software applications on the mobile station in response to removal of the authentication module from the mobile station.

In a second aspect, a mobile station and a portable authentication module for use in a mobile telecommunications system is provided. The authentication module includes a function for authenticating a subscriber in the mobile telecommunications system when the authentication module is inserted in the mobile station; and one or more software applications for customizing the mobile station. The mobile station and the authentication module are configured to transfer the one or more software applications to the mobile station in response to insertion of the authentication module into the mobile station, and then activating same, in order to customize the mobile station, and the mobile station, when customized, is configured to deactivate the one or more customizing software applications on the mobile station in response to removal of the authentication module from the mobile station.

In a third aspect, a portable authentication module for insertion into a mobile station in a mobile telecommunications system is provided. The authentication module comprises a function for authenticating a subscriber in the mobile telecommunications system when the authentication module is inserted in the mobile station. The authentication module also includes one or more software applications for customizing the mobile station, the one or more software applications being for transfer to the mobile station in response to insertion of the authentication module into the mobile station, and then activation thereon, in order to customize the mobile station. The authentication module further includes an activation agent software application which is for transfer to the mobile station in response to insertion of the authentication module into the mobile station, the activation agent software application being configured to control the mobile station in relation to the one or more customizing software applications, wherein the activation agent is configured to deactivate the one or more customizing software applications on the mobile station in response to removal of the authentication module from the mobile station.

In yet another aspect, a mobile station for use in a mobile telecommunications system is provided. The mobile station is for use with a portable authentication module. The authentication module comprises a function configured to authenticate a subscriber in the mobile telecommunications system when the authentication module is inserted in the mobile station; and one or more software applications configured to customize the mobile station, wherein the mobile station comprises an activation agent configured to control the mobile station in relation to the one or more customizing software applications. The mobile station is configured to transfer the one or more software applications to the mobile station, and then activating same, in response to insertion of the authentication module into the mobile station, and wherein the activation agent is configured to deactivate the one or more customizing software applications on the mobile station in response to removal of the authentication module from the mobile station.

### BRIEF DESCRIPTION OF THE DRAWINGS

FIG. 1 is a block diagram of a mobile communications network in accordance with an embodiment of the invention;

FIG. 2 is a block diagram of a mobile station according to an embodiment of the present invention;

FIG. 3 is a schematic diagram showing data stored in a memory of a portable authentication module according to an embodiment of the present invention; and

FIG. 4 is a flow diagram showing steps involved in the operation of the mobile station shown in FIG. 2 according to an embodiment of the present invention.

### DETAILED DESCRIPTION OF CERTAIN INVENTIVE EMBODIMENTS

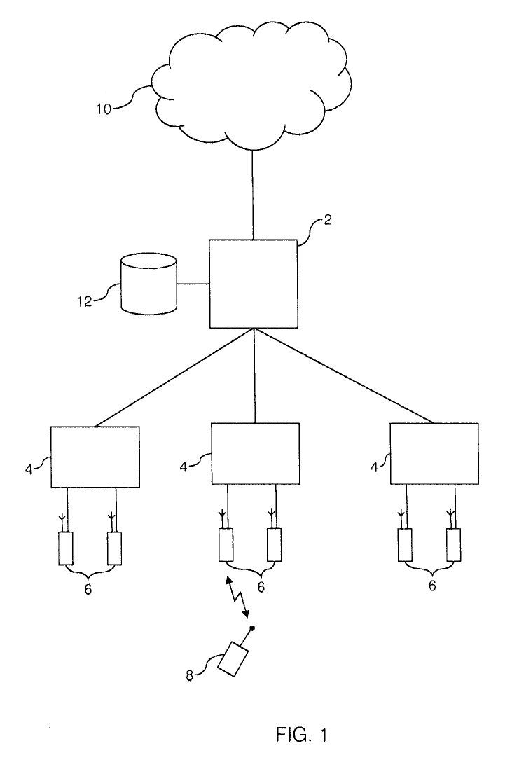

Before describing aspects of the embodiments in detail, a network environment within which embodiments are arranged to operate will be described with reference to FIG. 1 which shows an exemplary mobile communications network in the form of a GSM network, referred to as a public land mobile network (PLMN). This is in itself known and will not be described in great detail. Also, it should be understood that the invention applies to other types of mobile communications networks, and is not limited to GSM networks.

In this embodiment, a mobile switching centre (MSC) 2 is connected via communication links to a number of base station controllers (BSCs) 4. The BSCs 4 are dispersed geographically across areas served by the mobile switching centre 2. Each BSC 4 controls one or more base transceiver stations (BTSs) 6 located remote from, and connected by further communication links to, the BSC. Each BTS 6 transmits radio signals to, and receives radio signals from, mobile stations 8 which are in an area served by that BTS. That area is referred to as a “cell”. Cellular networks, such as a GSM network, are provided with a large number of such cells, which are ideally contiguous to provide continuous coverage over the whole network territory.

A mobile switching centre 2 is also connected via communications links to other mobile switching centres in the remainder of the mobile communications network 10, and to a public service telephone network (PSTN), which is not illustrated. The mobile switching centre 2 is provided with a home location register (HLR) 12 which is a database storing subscriber authentication data including, for each mobile station 8, a international mobile subscriber identity (IMSI) which is unique to the mobile station 8. Corresponding authentication data including the IMSI and encryption keys are also stored in the mobile station 8 in a portable authentication module, which is referred to herein further as a SIM although it should be understood that it could be a different type of portable authentication module, such as a USIM. The authentication data is stored in the SIM along with other standard data records and an authentication function for conducting authentication with respect to the mobile communications network 10.

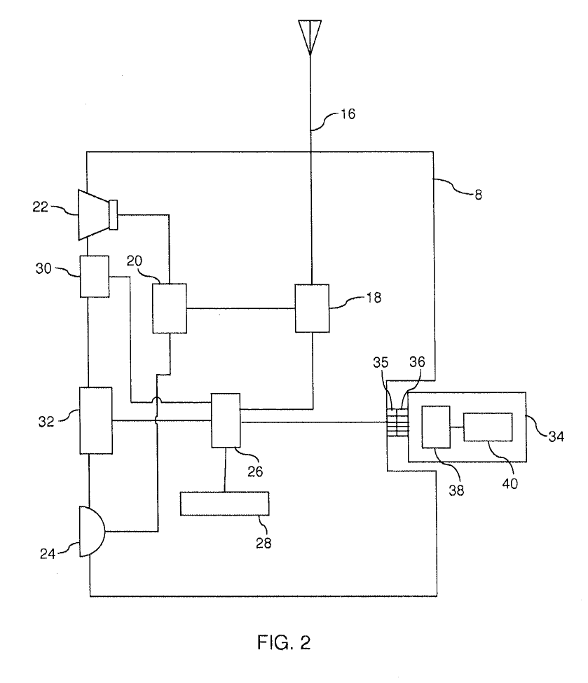

FIG. 2 shows a mobile station 8 according to an embodiment of the invention. The mobile station 8 includes a transmit/receive aerial 16, a radio frequency transceiver 18, a speech coder/decoder 20 connected to a loudspeaker 22 and a microphone 24, a processor circuit 26 and a non-volatile memory 28, for example EEPROM or Flash memory, an LCD display 30 and a manual input port (keypad) 32. The mobile station 8 is connected to a SIM 34 via interconnecting sets of electrical contacts 35, 36. The SIM 34 and mobile station 8 preferably implement a high speed data transfer protocol, such as the Universal Serial Bus (USB) protocol, for the transfer of data at high data rates between the mobile station 8 and SIM 34.

The SIM 34 comprises a data processor 38 and a non-volatile memory 40, for example EEPROM or Flash memory, for storing data according to embodiments of the invention. The memory of the SIM 34 in this embodiment is preferably relatively large, and may for example have a size of 64 Mb, 128 Mb, or above.

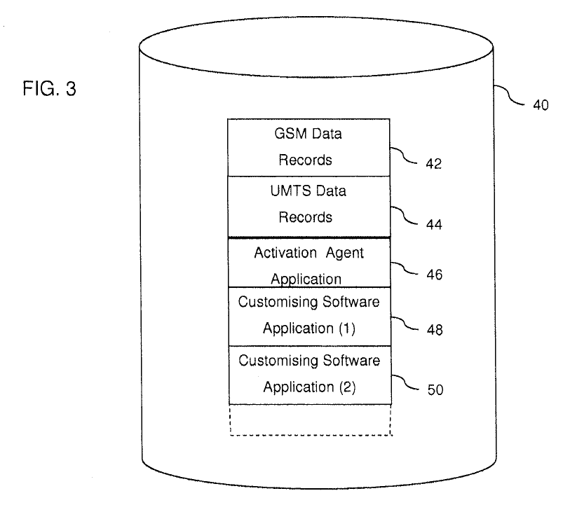

FIG. 3 illustrates the contents of the memory 40 of the SIM 34 schematically. The memory 40 includes a set of standard data records for the mobile station 8. The example shown in FIG. 3 includes two sets of standard data records, although only one set may be included. The first set of standard data records 42 are in this embodiment GSM data records, for use when the mobile station 8 is operating in a GSM mobile communications network. The second set of standard data records 44 are in this embodiment UMTS data records, for use when the mobile station 8 is operating in a UMTS mobile communications network. These standard data records 42, 44 consist of settings for the mobile station 8 and subscriber data, such a contacts data, which are used by the mobile station 8 to adapt the mobile station for use by the subscriber in the mobile communications network(s) to which the subscriber has access.

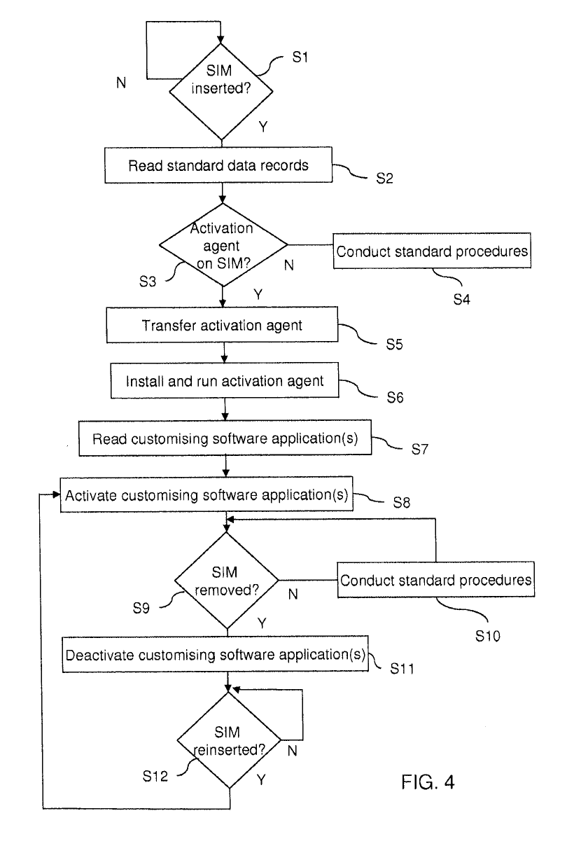

Also included in the memory 40, according to an embodiment of the invention, are a plurality of software applications for transfer and activation on the mobile station 8. The software applications include an activation agent 46 and one or more customizing software applications. In this example, two customizing software applications 48, 50 are provided, however it should be understood that any number may in practice be provided, depending on the amount of memory available in the SIM 34. The activation agent 46 is preferably stored in a predetermined location within the memory 40. Such a predetermined location may include a predetermined directory and/or a predetermined file name. The mobile station 8 is adapted according to an embodiment of the invention to have specific routines, which may be included within the operating system or other application platform of the mobile station 8, which are followed automatically on insertion of a SIM 34 into the mobile station 8, to detect the presence of an activation agent 46 within the memory 40, by searching for an activation agent 46 within the predetermined directory or with the predetermined file name mentioned above. Hence, the mobile station 8 can automatically detect and install the activation agent 46 in response to insertion of the SIM 34 within the mobile station 8. The procedure is described below in further detail in relation to FIG. 4.

The mobile station 8, before a SIM 34 is inserted, is in an inoperative state, and cannot yet be used for obtaining a normal service in a mobile communications network. In step S1, the mobile station 8 checks whether a SIM 34 is inserted within the SIM slot of the mobile station 8. When a SIM 34 is inserted, the mobile station 8 begins by reading the standard data records from the GSM data records 42 and/or the UMTS data records 44, step S2. Once all of the appropriate data records have been read and transferred to the non-volatile memory 28 of the mobile station 8, the mobile station checks whether there is an activation agent 46 stored on the SIM 34, step S3. If no activation agent 46 is found in the SIM 34, the mobile station 8 proceeds by conducting standard procedures, including authentication with the mobile network, allowing the subscriber to obtain services from the mobile network.

If an activation agent 46 is found on the SIM 34 in step S3, the mobile station 8 reads the activation agent 46 from the SIM 34 in step S5 and activates the activation agent 46 in step S6 by installing and running the application. The activation agent 46 controls the mobile station 8 in relation to the one or more customizing software applications 48, 50 stored on the SIM 34. The mobile station 8 reads the customizing software applications 48, 50 and transfers these to a non-volatile memory 28 of the mobile station 8, step S7. Next, the customizing software applications 48, 50 are each, in turn, activated, step S8, by installing the applications onto the mobile station 8. The subscriber may then in future run the application by selecting the application from a menu on the mobile station 8. The activation agent 46 may, in addition to activating the customizing software applications 48, 50 by installing them on the mobile station 8, also initiate the running of the applications, thereby providing customization features which are available by running the applications immediately in response to insertion of the SIM 34 into the mobile station 8. Furthermore, the activation agent 46 may add a customizing software application to a “start-up” list for the mobile station 8, such that, when the mobile station 8 is in future switched off and then switched back on again, the selected customizing software applications 48, 50 are automatically run on start up. After the customizing software applications 48, 50 have been activated by the activation agent 46 in some manner, and providing the SIM 34 is not removed (which is otherwise detected in step S9) the mobile station 8 conducts standard procedures, step SlO, including authentication of the mobile station 8 to the mobile communications network using the authentication function provided by the SIM 34, in order to provide the subscriber with access to services provided by the mobile communications network. If the SIM 34 is removed in step S9, the activation agent 46 detects this and, in response, operates in step SI 1 to deactivate the customizing software applications 48, 50. Such deactivation is preferably conducted in a manner such that the applications are not removed from the memory of the mobile station 8 entirely, indeed preferably the entire applications remain held in the memory 28 whilst inactive. This feature is provided so that the customizing software applications 48, 50 may be reactivated subsequently without retransferring entirely the customizing software applications 48, 50 from the SIM 34. In this embodiment, deactivation may comprise any of ending the running of the application on the mobile station 8, disabling the application, removing the application from the menu structure of the mobile station 8 and/or removing the application from the “start-up” list of the mobile station 8. Preferably, all of the above deactivation steps are carried out for each customizing software application as appropriate.

Note that, when the SIM 34 is removed, according to standard procedures the mobile station 8 is no longer capable of obtaining network services, and according to the invention the mobile station 8 is also now no longer customized with the customizing software applications 48, 50, because the customizing software applications 48, 50 are no longer active within the mobile station 8. Next, the mobile station 8 waits until the SIM 34 is reinserted in step S 12. If the SIM 34 is reinserted, the activation agent 46 operates to reactivate the customizing software applications 48, 50 within the mobile station 8, thereby providing the appropriate customization features in response to the reinsertion of the SIM 34 into the mobile station 8. Note also that, if a different SIM is inserted, the customizing software applications are not reactivated. If the new SIM includes a different activation agent, the previous activation agent is overwritten and the previous customizing software applications are deleted.

The customizing software applications 48, 50 may for example include a “home screen utility” application, a “back up utility” application, one or more game applications and/or an “update utility” application, although many other customizing software applications are envisaged. The “home screen utility” application provides a home screen customization function which customizes the home screen layout and functionality of the mobile station 8 to be unique to the mobile operator. The “back up utility” application provides a backup function which is used to regularly transmit data, such as contacts data and calendar data, stored by the subscriber on the mobile station 8 to a network side store such that, if the mobile station 8 is lost or stolen, the subscriber data is not lost and can be restored onto a new mobile station 8. The game application provides a game function for the amusement of the user. The “update utility” application includes a software update function to regularly check for updates to the customizing software applications and/or other applications stored on the mobile station 8, over the air by querying an update application server in the network. The update utility application also includes a function to download and install entirely new applications over the air from an update application server in the network.

Each customizing software application is in this embodiment written for a particular applications platform, suitable for the mobile station on which the application is to be installed. In preferred embodiments of the invention, the authentication module includes a separate activation agent, and a set of corresponding customizing software applications, for each of a plurality of different applications platforms. The mobile station is preferably arranged to automatically select and install the correct activation agent for their respective applications platform in response to the insertion of the authentication module into the mobile station. The different applications platforms may include one or more of the Microsoft Windows Mobile™, Microsoft Windows CE™, Symbian™ and Linux™ operating systems and the Java™ and Brew™ applications platforms. In further embodiments of the invention, each customizing software application may store data, generated by the customizing software application in use, on the SIM 34. This data may for example include user settings, historical data associated with an application (e.g. a last backup date for a backup utility, a high score setting for a game, an update counter), etc. This data is generated and stored on the SIM 34 by a customizing software application, after the customizing software application has been transferred to and installed on the mobile station and during use of the application. Then, when the SIM 34 is removed and ported to a different mobile station 8, the data stored by each customizing software application is also ported with it, rather than being lost, along with the customizing software application itself.

Note that, whilst in the above embodiments, the customizing software applications are held in the mobile station after the SIM is removed, in an alternative embodiment the applications are removed automatically when the SIM is removed. However, this has the disadvantage that the applications must be transferred and installed afresh each time the SIM is removed. Indeed, whilst the applications are in the above embodiments stored in non-volatile memory on the mobile station after being transferred from the SIM, they may alternatively be stored in volatile memory. However, this has the disadvantage that they must be transferred and installed afresh each time the mobile station is switched off.

It is to be understood that any feature described in relation to any one embodiment may be used alone, or in combination with other features described, and may also be used in combination with one or more features of any other of the embodiments, or any combination of any other of the embodiments.

Furthermore, equivalents and modifications not described above may also be employed without departing from the scope of the invention, which is defined in the accompanying claims.

What is claimed is:

1. A method of customizing a mobile station in a mobile telecommunications system, the method comprising:
providing a portable authentication module for insertion into the mobile station, the authentication module comprising a function for authenticating a subscriber in the mobile telecommunications system when the authentication module is inserted in the mobile station, and the authentication module further comprising one or more software applications for customizing the mobile station;
transferring the one or more customizing software applications from the authentication module onto the mobile station in response to insertion of the authentication module into the mobile station, and then activating the one or more customizing software applications on the mobile station, in order to customize the mobile station; and
de-activating the one or more customizing software applications on the mobile station in response to removal of the authentication module from the mobile station.

2. The method of claim 1, wherein the deactivation is conducted without removing the one or more customizing software applications from the mobile station, and wherein the method further comprises, in response to reinsertion of the authentication module into the mobile station, reactivating the one or more customizing software applications without retransferring entirely the one or more customizing software applications from the authentication module.

3. The method of claim 1, wherein the method further comprises arranging the system such that an activation agent software application is installed on the mobile station in response to insertion of the authentication module into the mobile station, the activation agent software application controlling the mobile station in relation to the one or more customizing software applications.

4. The method of claim 3, wherein the activation agent software application is stored in the portable authentication module.

5. The method of claim 4, wherein the activation agent software application is configured to initiate the transfer of the one or more customizing software applications to the mobile station.

6. The method of claim 3, wherein the activation agent software application is configured to control the deactivation of the one or more customizing software applications in response to removal of the authentication module from the mobile station.

7. A mobile station and a portable authentication module for use in a mobile telecommunications system,
the authentication module comprising:
a function for authenticating a subscriber in the mobile telecommunications system when the authentication module is inserted in the mobile station; and
one or more software applications for customizing the mobile station,
the mobile station and the authentication module being configured to transfer the one or more software applications to the mobile station in response to insertion of the authentication module into the mobile station, and then activating same, in order to customize the mobile station, and
the mobile station, when customized, being configured to deactivate the one or more customizing software applications on the mobile station in response to removal of the authentication module from the mobile station.

8. The mobile station of claim 7, wherein the mobile station, when customized, is configured to:
deactivate the one or more customizing software applications without removing the one or more customizing software applications from the mobile station; and
in response to reinsertion of the authentication module into the mobile station, reactivate the one or more customizing software applications without retransferring entirely the one or more customizing software applications from the authentication module.

9. A portable authentication module for insertion into a mobile station in a mobile telecommunications system, the authentication module comprising:
a function for authenticating a subscriber in the mobile telecommunications system when the authentication module is inserted in the mobile station,
one or more software applications for customizing the mobile station, the one or more software applications being for transfer to the mobile station in response to insertion of the authentication module into the mobile station, and then activation thereon, in order to customize the mobile station, and
an activation agent software application which is for transfer to the mobile station in response to insertion of the authentication module into the mobile station, the activation agent software application being configured to control the mobile station in relation to the one or more customizing software applications,
wherein the activation agent is configured to deactivate the one or more customizing software applications on the mobile station in response to removal of the authentication module from the mobile station.

10. The portable authentication module of claim 9, wherein the activation agent is capable of:
deactivating the one or more customizing software applications without removing the one or more customizing software applications from the mobile station; and
in response to reinsertion of the authentication module into the mobile station, reactivating the one or more customizing software applications without retransferring entirely the one or more customizing software applications from the authentication module.

11. A mobile station for use in a mobile telecommunications system, the mobile station being for use with a portable authentication module,
the authentication module comprising:
a function configured to authenticate a subscriber in the mobile telecommunications system when the authentication module is inserted in the mobile station; and
one or more software applications configured to customize the mobile station,
wherein the mobile station comprises an activation agent configured to control the mobile station in relation to the one or more customizing software applications,
wherein the mobile station is configured to transfer the one or more software applications to the mobile station, and then activating same, in response to insertion of the authentication module into the mobile station, and
wherein the activation agent is configured to deactivate the one or more customizing software applications on the mobile station in response to removal of the authentication module from the mobile station.

12. The mobile station of claim 11, wherein the deactivation is conducted without removing the one or more customizing software applications from the mobile station.

13. The mobile station of claim 12, wherein in response to reinsertion of the authentication module into the mobile station, the activation agent is configured to reactivate the one or more customizing software applications.

14. A portable authentication module for insertion into a mobile station in a mobile telecommunications system, the authentication module comprising:
means for authenticating a subscriber in the mobile telecommunications system when the authentication module is inserted in the mobile station;
means for customizing the mobile station in response to insertion of the portable authentication module into the mobile station, and
means for controlling the mobile station in relation to the means for customizing the mobile station;
wherein the means for controlling the mobile station is further configured to deactivate the means for customizing the mobile station in response to removal of the portable authentication module from the mobile station.
